(19) United States
(12) Patent Application Publication
(10) Pub. No.: US 2006/0076536 A1
(43) Pub. Date: Apr. 13, 2006

(54) Oxygen scavenging pharmaceutical package and methods for making same

(76) Inventor: Scott R. Barshied, Harleysville, PA (US)

Correspondence Address: SUTHERLAND ASBILL & BRENNAN LLP, 999 PEACHTREE STREET, N.E., ATLANTA, GA, 30309, US

(21) Appl. No.: 11/217,579

(22) Filed: Sep. 1, 2005

Related U.S. Application Data
(60) Provisional application No. 60/614,344, filed on Sep. 29, 2004.

(51) Int. Cl. C01B 3/00

(52) U.S. Cl. 252/188.28

(57) ABSTRACT

The present invention relates generally to a pharmaceutical packaging for increasing the product shelf life, reducing discoloration, and reducing degradation of pharmaceuticals by reducing the oxygen level present in the pharmaceutical package. The pharmaceutical package comprises a substantially oxygen impermeable container, at least one oxygen scavenging element disposed in the container, and at least one packaged pharmaceutical product disposed in the oxygen impermeable container.

### CROSS REFERENCE TO RELATED APPLICATIONS

This application claims priority under 35 USC § 119(e) to U.S. Provisional Patent Application 60/614,344 filed on Sep. 29, 2004, the disclosure of which is expressly incorporated herein by reference.

### FIELD OF THE INVENTION

The present invention relates generally to a pharmaceutical packaging and methods of increasing pharmaceutical shelf life. More particularly, this invention relates to packaging oxygen sensitive pharmaceuticals and reducing discoloration and degradation of the pharmaceutical by reducing the oxygen level present in the pharmaceutical package.

### BACKGROUND OF THE INVENTION

Chemically, pharmaceutical formulations/products often include alcohols, phenols, aldehydes, ketones, esters, ethers, acids, salts, alkaloids, glycosides, or the like, each with reactive chemical groups having different susceptibilities toward chemical instability such as the destructive process of oxidation. The presence of oxygen may lead to undesired discoloration and decrease in the potency of such pharmaceutical products. Therefore, limiting the exposure of oxygen-sensitive products to oxygen maintains and enhances the quality and shelf-life of some pharmaceutical products. Limiting the oxygen exposure of oxygen sensitive pharmaceutical products in a packaging system, maintains the quality of the product and avoids degradation or damage due to oxygen contamination. In addition, such packaging also keeps the product in inventory longer, thereby reducing costs incurred from waste and having to restock.

Oxygen contamination of pharmaceutical packages mainly occurs via two methods: (i) oxygen present in the head space and (ii) diffused oxygen. The head space oxygen is the oxygen remaining in the package after the product has been sealed off within packaging materials. Diffused oxygen is the oxygen which diffuses or migrates directly through the package walls or enters the package through voids or holes in the package, such as through the seals. Contamination by head space oxygen occurs only when the package is initially sealed. By contrast, the diffused oxygen enters the package slowly from the time the package is sealed until it is opened by the consumer. Over time, an amount of oxygen may enter the package as diffused oxygen. It is therefore desirable to remove the relatively small amount of head space oxygen quickly, before the high oxygen concentration can damage or degrade the packaged product, and to remove diffused oxygen more slowly but continuously while the package is on the shelf, to prevent a significant buildup of oxygen over time. A package capable of quickly removing head space oxygen and absorbing diffused oxygen over time would provide significant protection for oxygen-sensitive products.

In the pharmaceutical packaging industry, oxygen contamination can be reduced using a modified atmosphere such as nitrogen purging. Alternatively, vacuumed packed pharmaceutical products may also decrease the amount of oxygen with the head space. However, modified atmosphere or vacuumed packaging processes do not prevent later contamination from diffused oxygen. In fact, a package with a partial or full vacuum would likely increase the oxygen permeation rate of the package walls.

Pharmaceutical packages have also employed the use of barrier films. In barrier film packaging processes, materials are used in the package walls which physically prevent oxygen from entering the package interior. Such processes, however, do not prevent contamination by head space oxygen, or prevent diffusion of oxygen from holes or voids in the package seals. This problem has been addressed in the food packaging industry by incorporating oxygen scavengers to reduce the amounts of oxygen within the food package.

Thus, the use of oxygen absorbers in the food industry for preservation of foods is well known. However, less is known with respect to stabilization against oxidation of pharmaceuticals with oxygen absorbers. In the food industry, an oxygen scavenger may be incorporated into the packaging structure itself, for example by constructing the package walls with an oxygen scavenging polymer. Previous packaging systems incorporating oxygen scavenging materials use only one such material in a given package, thus producing a package with homogeneous oxygen scavenging properties. For example, Mitsubishi Gas Corporation introduced iron plus carbonate salt sachets for use in stabilizing packaged foods by preventing oxidation.

In spite of the use of oxygen absorbers in the food industry and more limited reports in the pharmaceutical world, there is no definite information or guidance as to the appropriateness of this technology or best practice methods for use with solid or liquid dosage form pharmaceutical products. In particular, there is no information with respect to the efficacy of oxygen absorbers in pharmaceutical package using a drug that has a high sensitivity to oxygen. Thus, there is a still a need in the pharmaceutical packaging art to provide a pharmaceutical packaging which reduces or eliminates the amount of oxygen contact with a solid or liquid dosage pharmaceutical product.

### SUMMARY OF THE INVENTION

Objects and advantages of the invention will be set forth in part in the following description, or may be obvious from the description, or may be learned through practice of the invention. Unless otherwise defined, all technical and scientific terms and abbreviations used herein have the same meaning as commonly understood by one of ordinary skill in the art to which this invention pertains. Although methods and compositions similar or equivalent to those described herein can be used in the practice of the present invention, suitable methods and compositions are described without intending that any such methods and compositions limit the invention herein.

The present invention addresses the above-described need by providing a pharmaceutical package comprising at least one substantially oxygen impermeable container, at least one oxygen scavenging element disposed in the container, and at least one packaged pharmaceutical product disposed in the container.

This invention also encompasses a method for packaging an oxygen sensitive pharmaceutical product comprising encasing at least one packaged pharmaceutical product and at least one oxygen scavenging element in at least one substantially oxygen impermeable container.

Other objects features and advantages of this invention will become apparent from the following detailed description of embodiments, drawings, and claims.

### BRIEF DESCRIPTION OF THE DRAWINGS

FIG. 1 is a perspective view of a pharmaceutical package in accordance with an embodiment of this invention with the oxygen impermeable container illustrated in phantom lines.

FIG. 2 is a is an expolded perspective view of a pharmaceutical package exemplifying the support tray as part of the oxygen impermeable container in accordance with an embodiment of this invention.

FIG. 3a is a plan view of a pharmaceutical package illustrating a plurality of packaged pharmaceutical products.

FIG. 3b is a plan view of a pharmaceutical package illustrating a plurality of packaged pharmaceutical products with first and second recesses in the support tray.

In describing the proffered embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose.

### DETAILED DESCRIPTION OF THE EMBODIMENTS

Reference now will be made in detail to the presently proffered embodiments of the invention, one or more examples of which are illustrated in the accompanying drawings. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment, can be used on another embodiment to yield a still further embodiment. Thus, it is intended that the present invention cover such modifications and variations within the scope of the appended claims and their equivalents.

As summarized above, this invention encompasses a pharmaceutical package comprising at least one substantially oxygen impermeable container, at least one oxygen scavenging element disposed in the container, and at least one packaged pharmaceutical product disposed in the container; and a method for packaging an oxygen sensitive pharmaceutical product comprising encasing at least one packaged pharmaceutical product and at least one oxygen scavenging element in at least one substantially oxygen impermeable container.

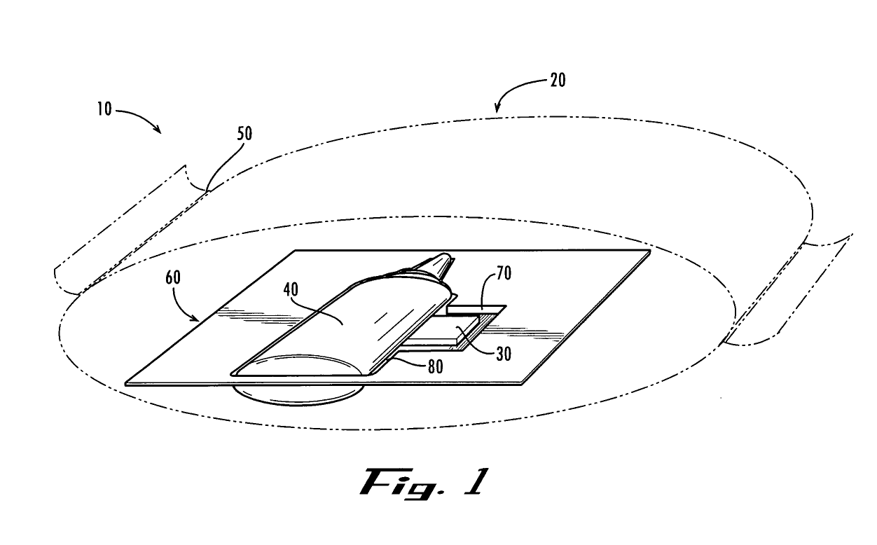

Turning to FIG. 1, a pharmaceutical package 10 made in accordance with an embodiment of this invention is illustrated. It has been discovered that the pharmaceutical package provides an improved shelf-life or storage of pharmaceutical products and a reduction in degradation and/or discoloration of pharmaceutical products. In particular, the pharmaceutical package reduces or eliminates the oxygen levels within the pharmaceutical package as well as prevents or reduces the amount of oxygen diffusing into the pharmaceutical package thereby protecting oxygen sensitive pharmaceutical products from reacting with oxygen.

As used herein, the term “pharmaceutical product” refers to any liquid or solid dosage form of a natural or synthetic compound which has therapeutic or medicinal value.

As used herein, the term “oxygen sensitive” refers to any pharmaceutical product which degrades or discolors when contacted with oxygen.

The pharmaceutical package 10 comprises at least one substantially oxygen impermeable container 20, at least one oxygen scavenging element 30 disposed in the container 20, and at least one packaged pharmaceutical product 40 disposed in the container 20.

As used herein, the term “substantially oxygen impermeable container” refers to any material with barrier properties substantially preventing or reducing the ingress or diffusion of oxygen. Desirably the oxygen impermeable container 20 prevents the transmission of oxygen at a rate of at least equal to or less than 80 cc/100 in²/24 hours (as measured by Mocon 1000 at 0% relative humidity and 23° C.). Preferably, the transmission of oxygen through the oxygen impermeable container is at a rate of at least equal to or less than 50 cc/100 in²/24 hours. More preferably, the transmission of oxygen through the oxygen impermeable container is at a rate of at least equal to or less than 35 cc/100 in²/24 hours. Even more preferably, the transmission of oxygen through the oxygen impermeable container is at a rate of at least equal to or less than 25 cc/100 in²/24 hours. Even yet more preferably, the transmission of oxygen through the oxygen impermeable container is at a rate of at least equal to or less than 10 cc/100 in²/24 hours. Even yet further more preferably, the transmission of oxygen through the oxygen impermeable container is at a rate of at least equal to or less than 5 cc/100 in²/24 hours. Oxygen transmission rate may be measured by a reliable method, such as ASTM D3985. In particular, oxygen transmission rate may be measured with a Mocon OXYTRAN 1000 instrument (available from Modern Controls, Inc., Elk River, Minn.) at 23° C. and 0% relative humidity. Suitable oxygen impermeable container material includes, but is not limited to metal foil, laminate comprising metal foil, metallized film, glass, silicon oxide coated films, aluminum oxide coated films, liquid crystal polymer layers, and layers of nano-composites, metal or metal, alloys, acrylic, and amorphous carbon and combinations thereof. Non-limiting examples of metal foil include but are not limited to aluminum; zinc; nickel; tin; iron; copper; chromium; cobalt; silver; gold; magnesium; manganese; lead; or alloy thereof, such as brass, bronze, steel, or the like; plates such as tin plates, galvanized iron; a composite of nickel on aluminum; a composite film of iron on aluminum; a composite of zinc on silver; a composite of zinc on copper; a composite of zinc on aluminum; metal oxides such as aluminum oxide, iron oxide, silver oxide; and combinations thereof.

Non-limiting examples of laminate layers for use with a barrier material include but are not limited to polypropylene, polyethylene, polyester, polystyrene, polyamide, EVOH, polyurethane, polyacrylonitrile, polyvinyl chloride, poly(vinylidene dichloride), polyethylene terephthalate, silica, and polyamides copolymers thereof, or blends thereof. The oxygen impermeable container may be flexible, rigid, or a combination of both. Typical rigid or semi-rigid articles include plastic, paper or cardboard, glass, acrylic, or metal which have wall thicknesses in the range of 100 to 1000 micrometers. Typical flexible packages include those used to package many pharmaceutical items, and may have thicknesses of 5 to 250 micrometers. Preferably, the walls of such articles comprise multiple layers of material.

In one embodiment, the oxygen impermeable container 20 further comprises at least one resealable closure 50. As used herein, the term “resealable closure” refers to any mechanism which allows the oxygen impermeable container to open and close at least two times. Non-limiting examples of resealable closures include but are not limited to ziploc-like mechanisms, adhesives, clasps, screws, and zipper-like mechanisms.

In another embodiment, the oxygen impermeable container 20 may be formed by sealing the film together in any effective ways known to those skilled in the art. As used herein, the term “seal” refers to any seal of a first region of the oxygen impermeable container with a second region of the oxygen impermeable container, wherein the seal is formed by heating the regions to at least their respective seal initiation temperatures. Suitable seals include, but are not limited to, lap seals, fin seals, butt seals, and the like, and the seals can be made by any of the suitable means known to those skilled in the art such as heating sealing, or the application of cold or hot melt adhesives, a heated bar, hot air, infrared radiation, ultrasonic sealing, radio frequency sealing, laser sealing, and the like.

It is appreciated by those skilled in the art that the shape of the oxygen impermeable container may be of any shape or size suitable for the desired pharmaceutical product to be packaged or enclosed. For example, in accordance with one embodiment of the invention, the oxygen impermeable container 20, may be pillowed shaped as shown in FIG. 1. The oxygen impermeable container may also take the shape of the packaged pharmaceutical product. Other non-limiting examples of the shape include, but are not limited to, square, rectangular, circular, oval, trapezoidal, triangular, pouched, tubular, or any other geometric or non-geometric shape suitable of enclosing or packaging a packaged pharmaceutical product.

In another embodiment, the space within the oxygen impermeable container comprises less than 5% by volume of oxygen, and preferably less than 1% by volume of oxygen, upon equilibrium. It is appreciated that equilibrium may not be achieved immediately subsequent to sealing the oxygen impermeable container and thus the oxygen within the oxygen impermeable container may initially be higher than 5%.

In yet another embodiment of the present invention, the oxygen impermeable container 20 comprises a plurality of packaged pharmaceutical products 40 disposed in the container. In particular embodiments, the spacing disposed within the oxygen impermeable container may be filled with air. Alternatively, the pharmaceutical package 10 can be vacuumed packed or purged with inert gas, but inert gas purging is optional.

As used herein, the term “packaged pharmaceutical product” refers to any pharmaceutical product which has been encased, enclosed, or packaged prior to encasing or enclosing within the oxygen impermeable container of the present invention. For example, FIG. 1 illustrates a bottled packaged pharmaceutical product 40. Other non-limiting examples of packaged pharmaceutical products include but are not limited to those packaged in rigid or flexible containers or wrapping such as cartons, tubes, films, and blister packing.

In accordance with an embodiment of the present invention, the packaged pharmaceutical product 40 comprises a pharmaceutical product disposed in an oxygen permeable package. Furthermore, the pharmaceutical product is oxygen sensitive. Non-limiting examples of oxygen sensitive pharmaceutical products include, but are not limited to, pharmaceutical products with alcohol, phenol, aldehyde, ketone, ester, ether, acid, salt, alkaloid, glycoside, amine, amino or other functional groups which reacts with oxygen. For example, an oxygen sensitive pharmaceutical product is 5-amino-2-hydroxybenzoic acid (also known as mesalamine or 5-aminosalicylic acid).

The oxygen scavenging element 30 of the present invention is preferably arranged within the oxygen impermeable container 20 so as to most effectively remove oxygen from a particular source. The most effective placement of oxygen scavenging materials in the oxygen impermeable package depends on the configuration (e.g., surface area-to-volume ratio), pharmaceutical product type, packaging conditions, anticipated storage conditions, and other such factors. Thus, one of ordinary skill in the art is able to ascertain the best placement of the oxygen scavenging element in the oxygen impermeable container. In one example, the oxygen scavenging element is centrally located within the oxygen impermeable container. In another example the oxygen scavenging element is placed in proximity with the seals of the oxygen impermeable container. In another yet another example, the oxygen scavenging element is placed in proximity with the packaged pharmaceutical product.

In a particular embodiment, there is at least one oxygen scavenging element disposed within the oxygen impermeable container 20. In alternative embodiments, there may be one oxygen scavenging element for every seal or every packaged pharmaceutical product.

As used herein, the term “oxygen scavenging element” refers to is a substance that consumes, depletes or reduces the amount of oxygen from a given environment without negatively affecting the pharmaceutical product. Suitable oxygen scavenging elements are well-known to those skilled in the art. Non-limiting examples of oxygen scavenging elements include but are not limited to compositions comprising metal particulates reactive with oxygen such as transition metals selected from the first, second or third transition series of the periodic table of the elements, and include manganese II or III, iron II or III, cobalt II or III, nickel II or III, copper I or II, rhodium II, III or IV, and ruthenium. The transition metal is preferably iron, nickel or copper. An example of an iron oxygen scavenging element is D500 from Multisorb. Other commercially available oxygen scavengers may also be purchased from companies such as Mitsubishi, Dow, or the like. Other examples of oxygen scavenging element may be enzymes which consumes, depletes or reduces the amount of oxygen from the given environment without negatively affecting the pharmaceutical product.

The oxygen scavenging element may be placed within a pouch, sachet, or any enclosures which allows contact with oxygen gas within the oxygen impermeable container.

In another embodiment of the present invention, at least one oxygen scavenging element is disposed within the space within the oxygen impermeable container and at least one oxygen scavenging element is fused within the oxygen impermeable container 20 and/or within the support tray 60.

A useful placement of the different oxygen scavenging element when fused within the oxygen impermeable container is a multilayer or laminate arrangement or a block arrangement, where entire sections of the oxygen impermeable container are formed primarily from oxygen scavenging element. Suitable oxygen scavenging elements for fusing with the oxygen impermeable container are well-known to those skilled in the art, and include compositions of one or more oxidizable organic polymers in the presence of a metal catalyst. The oxygen scavenging properties of certain oxidizable polymer/catalyst compositions are activated upon exposure to actinic (e.g., ultra violet or visible light) or electron beam radiation; see, for example, U.S. Pat. No. 5,981,676 of Gauthier et al., U.S. Pat. No. 5,776,361 of Katsumoto et al. and U.S. Pat. No. 5,736,616 of Ching et al., the disclosures of which are herein incorporated by reference in their entirety. Radiation-activatable compositions of oxidizable organic polymers and metal catalysts are preferred.

Oxidizable organic polymers suitable for use in radiation activatable, oxygen scavenging elements are well-known in the art, and include substituted or unsubstituted ethylenically unsaturated hydrocarbons and mixtures thereof, such as polybutadiene, polyisoprene, and styrene-butadiene block copolymers, as well as those described in U.S. Pat. Nos. 5,211,875 and 5,346,644 to Speer et al. (the disclosures of which are hereby incorporated by reference in their entirety) and U.S. Pat. No. 5,981,676 to Gauthier et al., supra. Other suitable oxidizable organic polymers include polyterpenes as disclosed in U.S. Pat. No. 5,776,361 supra; poly(meta-xylenediamine-adipic acid) (also known as MXD6); acrylates which can be prepared by transesterification of poly(ethylene-methyl acrylate), such as poly(ethylene-methylacrylate-benz-ylacrylate), poly(ethylene-methylacrylate-tetrahydrofurfurylacrylate), poly(ethylene-methyl acrylate-nopolacrylate) and mixtures thereof, as disclosed in U.S. Pat. No. 5,627,239, the disclosure of which is hereby incorporated by reference in its entirety, and polyethylenic compounds with pendant or terminal moieties comprising benzylic, allylic, or ether-containing radicals as disclosed in U.S. Pat. No. 5,736,616 supra. Mixtures of two or more oxidizable polymers may also be used. Particularly preferred oxidizable polymers are substituted or unsubstituted ethylenically unsaturated hydrocarbons, polyvinylidene chloride and polyethylenic compounds with pendant 3-cyclohexenyl moieties such as ethylene-cyclohexenylmethyl acrylate copolymer (ECHA) or ethylene-methylacrylate-cyclohexeneylmethyl acrylate terpolymer (EMCM).

Metal catalysts are also well-known in the art, and include transition metal catalysts which can readily interconvert between at least two oxidation states. The transition metal catalyst may also be in the form of a transition metal salt. The oxidation state of the transition metal in the catalyst, when mixed with the oxidizable polymer, is not necessarily that of the active form. Suitable transition metal catalysts comprise transition metals selected from the first, second or third transition series of the periodic table of the elements, and include manganese II or III, iron II or III, cobalt II or III, nickel II or III, copper I or II, rhodium II, III or IV, and ruthenium. The transition metal is preferably iron, nickel or copper, more preferably manganese and most preferably cobalt. Suitable counterions for the metal include chloride, acetate, stearate, palmitate, 2-ethylhexanoate, neodecanoate or naphthenate. Particularly preferable transition metal salts include cobalt (II) 2-ethylhexanoate and cobalt (II) neodecanoate. The transition metal salt may also be an ionomer, in which case a polymeric counterion is employed. Such ionomers are well known in the art.

The oxygen scavenging element may be used in flexible or rigid single layer or multilayer articles. The layers comprising the oxygen scavenging element may be in any useful form; for example, stock films, including “oriented” or “heat shrinkable” films, which may ultimately be processed as bags or other flexible packages. The layers of oxygen scavenging element may also be in the form of sheet inserts to be placed in a cavity of the oxygen impermeable container. In rigid articles, such as, the layer of oxygen scavenging element may be within the oxygen impermeable container walls or in the form of a liner placed with or in the oxygen impermeable container lid or cap. The oxygen scavenging element layer may also be coated or laminated onto any one of the articles mentioned above, or coated onto a solid support, such as a polymeric (i.e., polyester) film.

In another embodiment of the present invention, a support tray 60 disposed within the oxygen impermeable container 20 is provided for supporting at least one oxygen scavenging element 30 and at least one packaged pharmaceutical product 40 as shown in FIG. 1. The support tray 60 is formed from thermoplastic such as laminate, metal foil, laminate comprising metal foil, metallized film, glass, silicon oxide coated films, aluminum oxide coated films, liquid crystal polymer layers, and layers of nano-composites, metal or metal alloys, acrylic, or amorphous carbon, paper or other cellulose derived compounds, or a combination thereof. Non-limiting thermoplastic include, but is not limited to, low density polyethylene, high density polyethylene, polypropylene, polystyrene (e.g. high impact polystyrene), and polycarbonate.

The support tray 60 may be of any size or shape suitable to for supporting at least one oxygen scavenging element 30 and at least one packaged pharmaceutical product 40. In it appreciated oxygen impermeable container comprises at least one support tray. If more than one support tray 60 is disposed within the oxygen impermeable container 20, the support tray 60 may be stackable or connected side by side using any means known in the art. In a sub embodiment, the support tray 60 comprises a first recess 70 for receiving at least one oxygen scavenging element 30. In another sub-embodiment, the support tray 60 comprises a second recess 80 for receiving at least one packaged pharmaceutical product 40.

The support tray 60 of the present invention may further comprise at least one attachment element. As used herein, the term “attachment element” refers to any means for securing either the oxygen scavenging element or the packaged pharmaceutical product to the support tray. Non-limiting examples of attachment element include but are not limited to adhesives, Velcro, staple, nail, screw, thread, wire, sliding grove, or a combination thereof.

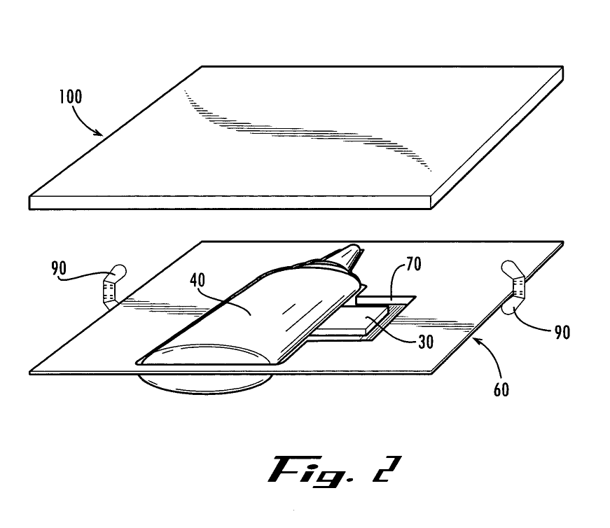

In another embodiment, the support tray may act as a part of the oxygen impermeable container. For example, in FIG. 2, the support tray 60 further comprises a closure element 90 for receiving a lid or top 100. As used herein, the term “closure element” refers to any means to secure the support tray to a second component which encloses the packaged pharmaceutical product. Non-limiting examples of closure element 90 include, but is not limited to, adhesives, Velcro, staple, nail, screw, thread, wire, sliding grove, or a combination thereof. The support tray 60 may further be configured in a manner which allows attachment to the second component without a need of a further closure element. For example, the support tray 60 may be circular or cylindrical with threading for receiving the second component as in a jar and lid mechanism. When the support tray 60 acts as part of the oxygen impermeable container, it is appreciated that the support tray should be formed with materials which provide barrier characteristics as described above in the oxygen impermeable container section.

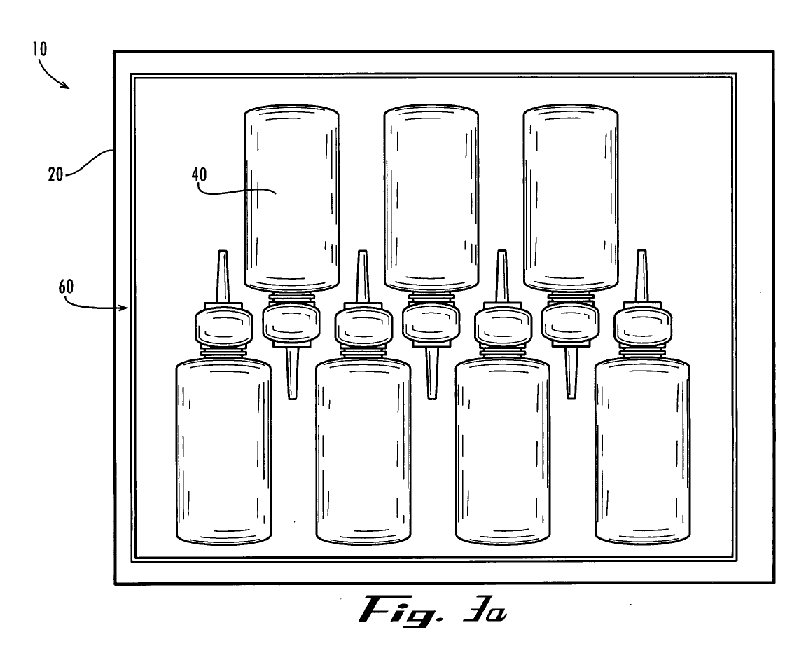

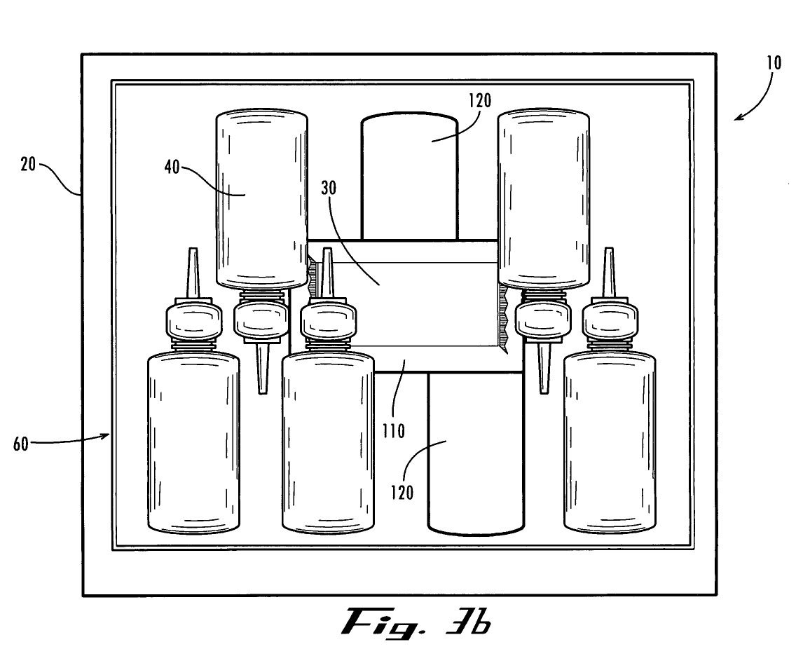

In another embodiment, the support tray 60 is configured to accept a plurality of packaged pharmaceutical products 40 as seen in FIG. 3a. FIG. 3b, further shows the first and second recesses 110 and 120 when two of the packaged pharmaceutical products have been removed.

The pharmaceutical package 10 (FIG. 1) of the present invention may be made according to any means known to those skilled in the art. For example, the pharmaceutical package 10 can be made by encasing the packaged pharmaceutical product 40 and the oxygen scavenging element 30 in the substantially oxygen impermeable container 20. While it is an option, inert gas purging of the container, such as nitrogen gas purging, is not necessary because the oxygen scavenging element removes the oxygen within the oxygen impermeable container. Thus, in one embodiment, air is encased in the container along with the at least one oxygen scavenging element which scavenges oxygen from the air within the container. In yet another embodiment, the step of encasing comprises vacuum packing the at least one oxygen scavenging element and the at least one packaged pharmaceutical product within the container. In another embodiment, a method for encasing the support tray 60 as described above is also provided. The packaged pharmaceutical product 40 may be a prescription, over-the-counter, or laboratory pharmaceutical.

The packaged pharmaceutical product 40 and/or support tray 60 can be packaged in the container 20 according to any known means in the art. The particular process used to seal the packaged pharmaceutical product 40 and oxygen scavenging element in the container 20, depends on the nature of the container. A standard “Form, Fill and Seal” (f/f/s) machine is suitable for some embodiments, particularly when the container is made of flexible material. Thus, in another embodiment, a method for packaging, the packaged pharmaceutical in a form-fill-seal system is provided comprising feeding the oxygen impermeable container flexible barrier material through the form-fill-seal system; folding and sealing the barrier material in the form-fill-seal system to form a flexible oxygen impermeable container 20 comprising an enclosure formed of the flexible barrier material; depositing the packaged pharmaceutical product 40, oxygen scavenging element 30, support tray 60 in the enclosure; and sealing the packaged pharmaceutical product, oxygen scavenging element and support tray in the enclosure. However, it is not necessary that the filling step and sealing step be performed at the same time as the forming operation. This procedure may be performed according to methods known to those of skill in the art, such that as disclosed in U.S. Pat. No. 5,135,464, col. 8, ll. 6-19.

In a standard horizontal f/f/s machine, a sheet of flexible barrier material such as a flexible multilayer barrier laminate film from a roll is fed to a plow assembly which folds the sheet in half. A plurality of closures are formed in the flexible sheet material wherein the closures are spaced apart and are perpendicular to the fold. The folded edge may function as the closure at the bottom edge of the enclosure, or if desired, a seam may be formed along the folded edge. The flexible sheet material is cut to form a plurality of enclosures comprising at least two layers, an open top edge, two sealed side edges and a bottom folded or sealed edge. The enclosure is filled and then a closure is formed on the flexible sheet material.

In a standard vertical f/f/s machine, flexible sheet material such as the flexible multilayer barrier laminate film from a roll is fed through a series of rollers. A bag-forming collar receives the sheet from the rollers and changes the sheet travel from a flat plane and shapes it around a bag forming tube. As the flexible sheet material moves down around the tube, the overlapped edges of the sheet are sealed with a vertical seal bar, thereby forming the flexible sheet material into a tube. The length of the flexible container will be equal to the extent of the flexible sheet material hanging down from the bottom of the tube. A filling tube is used to fill the container. A cross seal consisting of a front and rear cross-sealing jaw seals the container. Each cross sealing jaw comprises a top sealing section and a bottom sealing section with a container cutoff device in between. The top sealing section seals the bottom of an empty container suspended down from the forming tube, and the bottom portion seals the top of a filled container. The cutoff device, which can be a knife or a hot wire, operates during the jaw closing/sealing operation. Thus, when the jaws open, the filled container is released from the machine. Representative seals 50 are shown in FIG. 1.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

1. A pharmaceutical package comprising:
a substantially oxygen impermeable container;
at least one oxygen scavenging element disposed in the container; and
at least one packaged pharmaceutical product disposed in the container.

2. A pharmaceutical package as in claim 1 further comprising air disposed in the container, the at least one oxygen scavenging element disposed in the container so as to scavenge oxygen from the air within the container.

3. A pharmaceutical package as in claim 1 wherein the at least one oxygen scavenging element and the at least one packaged pharmaceutical component are vacuumed packed.

4. A pharmaceutical package as in claim 1 further comprising a support tray supporting the at least one oxygen scavenging element and the at least one packaged pharmaceutical product.

5. A pharmaceutical package as in claim 4 wherein the support tray is disposed in the container.

6. A pharmaceutical package as in claim 1 wherein the container comprises the support tray.

7. A pharmaceutical package as in claim 4 wherein the support tray has a first recess for receiving the at least one oxygen scavenging element.

8. A pharmaceutical package as in claim 7 wherein the support tray has a second recess for receiving the at least one packaged pharmaceutical product.

9. A pharmaceutical package as in claim 4 wherein the support tray is formed from thermoplastic.

10. A pharmaceutical package as in claim 9, wherein the thermoplastic is selected from the group consisting of low density polyethylene, high density polyethylene, polypropylene, polystyrene and polycarbonate.

11. A pharmaceutical package as in claim 9 wherein the thermoplastic further comprises an oxygen scavenger.

12. A pharmaceutical package as in claim 4 wherein the support tray further comprises an attachment element.

13. A pharmaceutical package as in claim 12, wherein the attachment element is an adhesive, Velcro, staple, nail, screw, thread, wire, or sliding groves.

14. A pharmaceutical package as in claim 4 wherein the support tray is stackable.

15. A pharmaceutical package as in claim 1 wherein the container is a flexible container.

16. A pharmaceutical package as in claim 1 wherein the container is a rigid container.

17. A pharmaceutical package as in claim 1 wherein the container comprises a metal foil, a laminate comprising metal foil, glass, oxides of silicon, or amorphous carbon.

18. A pharmaceutical package as in claim 17 wherein the metal foil comprises aluminum, zinc, nickel, tin, iron, copper, chromium, cobalt, silver, gold, magnesium, manganese, lead, galvanized iron, composite of nickel on aluminum, a composite film of iron on aluminum, a composite of zinc on silver, a composite of zinc on copper, a composite of zinc on aluminum, metal oxides, or a combination thereof.

19. A pharmaceutical package as claim 17 wherein the laminate comprises polypropylene, polyethylene, polyester, polystyrene, polyamide, EVOH, polyurethane, copolymers thereof, or blends thereof.

20. A pharmaceutical package as in claim 1 wherein the container comprises a resealable closure.

21. A pharmaceutical package as in claim 1 wherein the at least one oxygen scavenging element comprises metal particulate reactive with oxygen.

22. A pharmaceutical package as in claim 1 wherein the at least one oxygen scavenging element comprises particulate iron.

23. A pharmaceutical package as in claim 21 wherein the at least one oxygen scavenging element is substantially centrally located within the container.

24. A pharmaceutical package as in claim 1 wherein the at least one packaged pharmaceutical product comprises a pharmaceutical product disposed in an oxygen permeable package.

25. A pharmaceutical package as in claim 24 wherein the pharmaceutical product is oxygen sensitive.

26. A pharmaceutical package as in claim 24 wherein the pharmaceutical product is 5-amino-2-hydroxybenzoic acid.

27. A pharmaceutical package as in claim 1 further comprising a plurality of packaged pharmaceuticals disposed in the container.

28. A method for packaging an oxygen sensitive pharmaceutical product comprising encasing at least one packaged pharmaceutical product and at least one oxygen scavenging element in at least one substantially oxygen impermeable container.

29. A method as in claim 28 wherein the step of encasing comprises encasing air in the container and the at least one oxygen scavenging element in the container so as to scavenge oxygen from the air within the container.

30. A method as in claim 28 wherein the step of encasing comprises vacuum packing the at least one oxygen scavenging element and the at least one packaged pharmaceutical product within the container.

31. A method as in claim 28 further comprising the step of supporting the at least one oxygen scavenging element and the at least one packaged pharmaceutical product on a support tray.

32. A method as in claim 31 wherein the step of encasing comprises encasing the support tray in the container.

33. A method as in claim 28 wherein the container comprises the support tray.

34. A method as in claim 31 wherein the step of supporting comprises disposing the at least one oxygen scavenging element in a first recess in the support tray.

35. A method as in claim 34 wherein the step of supporting comprises disposing the at least one packaged pharmaceutical product in a second recess in the support tray.

36. A method as in claim 31 wherein the support tray is formed from thermoplastic.

37. A method as in claim 36 wherein the thermoplastic is selected from the group consisting of low density polyethylene, high density polyethylene, polypropylene, polystyrene and polycarbonate.

38. A method as in claim 36 wherein the thermoplastic further comprises an oxygen scavenger.

39. A method as in claim 31 further comprising attaching the at least one packaged pharmaceutical product central to the support tray.

40. A method as in claim 39 wherein the step of attaching comprises attaching the at least one packaged pharmaceutical product with an adhesive, Velcro, staple, nail, screw, thread, wire, or sliding groves.

41. A method as in claim 31 wherein the support tray is stackable.

42. A method as in claim 28 wherein the container is a flexible container.

43. A method as in claim 28 wherein the container is a rigid container.

44. A method as in claim 28 wherein the container comprises a metal foil, a laminate comprising metal foil, glass, oxides of silicon, or amorphous carbon.

45. A method as in claim 44 wherein the metal foil comprises aluminum, zinc, nickel, tin, iron, copper, chromium, cobalt, silver, gold, magnesium, manganese, lead, galvanized iron, composite of nickel on aluminum, a composite film of iron on aluminum, a composite of zinc on silver, a composite of zinc on copper, a composite of zinc on aluminum, metal oxides, or a combination thereof.

46. A method as in claim 44 wherein the laminate comprises polypropylene, polyethylene, polyester, polystyrene, polyamide, EVOH, polyurethane, copolymers thereof, or blends thereof.

47. A method as in claim 28 wherein the container comprises a resealable closure.

48. A method as in claim 28 wherein the at least one oxygen scavenging element comprises metal particulate reactive with oxygen.

49. A method as in claim 28 wherein the at least one oxygen scavenging element comprises particulate iron.

50. A method as in claim 49 wherein the at least one oxygen scavenging element is substantially centrally located within the container.

51. A method as in claim 28 wherein the at least one packaged pharmaceutical product comprises a pharmaceutical product disposed in an oxygen permeable package.

52. A method as in claim 51 wherein the pharmaceutical product is oxygen sensitive.

53. A method as in claim 51 wherein the pharmaceutical product is 5-amino-2-hydroxybenzoic acid.

54. A method as in claim 28 wherein the step of encasing comprises encasing a plurality of packaged pharmaceuticals disposed in the container.
